(19) United States
(12) Patent Application Publication
(10) Pub. No.: US 2004/0116547 A1
(43) Pub. Date: Jun. 17, 2004

(54) Dual curing silicone compositions

(75) Inventor: Lester D. Bennington, East Hartford, CT (US)

Correspondence Address: HOFFMANN & BARON, LLP, 6900 JERICHO TURNPIKE, SYOSSET, NY, 11791, US

(73) Assignee: LOCTITE CORPORATION

(21) Appl. No.: 10/674,659

(22) Filed: Sep. 30, 2003

Related U.S. Application Data
(63) Continuation of application No. 08/916,078, filed on Aug. 21, 1997, now abandoned.

(51) Int. Cl. C08G 2/00

(52) U.S. Cl. 522/29

(57) ABSTRACT

The present invention relates to dual curing silicone compositions which are capable of crosslinking when subjected to actinic radiation and/or heat. The compositions contain a reactive organopolysiloxane having a function group selected from the group consisting of (meth)acrylate, carboxylate, maleate, cinnamate and combinations thereof; a silicon hydride crosslinker; an organo-metallic hydrosilation catalyst; and a photoinitiator. These compositions can be cured to relatively thick films using UV light due to the presence of the specific olefinic unsaturated groups, and can also be partially or fully cured at room temperature or under thermal exposure. These compositions are particularly useful as conformal coatings, and in particular as coatings in electronic applications.

### FIELD OF THE INVENTION

The present invention relates to dual curing silicone compositions which are capable of cross-linking when subjected to actinic radiation and/or heat. These compositions remain essentially stable in the presence of moisture and have excellent shelf stability and pot life.

### BACKGROUND OF THE INVENTION

Silicone rubber and liquid compositions exist in various forms as characterized by their differing cure chemistry, viscosity, polymer type and purity. They can be formulated into one-part or two-part systems and a particular silicone composition can be engineered to be cured by more than one mechanism. Moisture-curing mechanisms, heat-curing mechanisms, and photo initiated mechanisms are among the means used to initiate cure, i.e., cross-linking of reactive silicones. These mechanisms are based on either condensation reactions, whereby moisture hydrolyzes certain groups on the silicone backbone, or addition reactions which can be initiated by a form of energy, such as electromagnetic radiation or heat. For example, reactive polyorganosiloxanes can be cured by heat in the presence of a peroxide. Alternatively, these reactive compounds can also be cured by heat in the presence of silicon hydride-containing (SiH) compound and a metallic hydrosilylation catalyst, such as an organo-platinum catalyst.

Dual-curing silicone compositions using ultraviolet light and moisture curing mechanisms are disclosed in U.S. Pat. No. 4,528,081 to Lien et al. and U.S. Pat. No. 4,699,802 to Nakos et al. These patents disclose compositions particularly useful for conformal coatings in electronic applications where the substrate has shadow areas which are not readily accessible to direct UV light and require moisture cure for cross-linking of those areas. Ordinarily, in addition to the photoinitiator present for radiation polymerization, a moisture curing catalyst such as an organotitanate must be present. Without the moisture curing catalyst, moisture cure does not ordinarily take place with any degree of certainty or in any predictable time frame. Thus, as a practical matter, without the moisture curing catalyst, the moisture curing aspect of these compositions would not be practical for use.

U.S. Pat. No. 4,587,173 to Eckberg, discloses dual curing silicone compositions using heat and UV light as separate cross-linking mechanisms. This patent discloses a reactive polyorganosiloxane which requires direct silicon-bonded hydrogen atoms and direct silicon-bonded alkenyl radicals on the same or different polysiloxane chains. These compositions also contain a photoinitiator and a precious metal or precious metal-containing hydrosilation catalyst. The presence of the photoinitiator allows cross-linking of the silicon-bonded hydrogen atoms and silicon-bonded alkenyl radicals. These compositions are said to be able to cross-link at room temperature or at elevated temperatures by the precious metal catalysis of the silicon-bonded hydrogen atoms and silicon-bonded alkenyl radicals. Platinum is among the catalysts used for the thermal hydrosilation cure reaction. Moreover, Eckberg requires a peroxide, which can decompose over time even at room temperature and thereby limit shelf-life.

U.S. Pat. No. 4,603,168 to Sasaki et al. discloses a method of curing organopolysiloxane compositions which require the use of heat in combination with ultraviolet radiation. The compositions disclosed therein contain an organopolysiloxane having per molecule at least two alkenyl groups bonded directly to the silicone atom. Other organic groups may also be present, such as alkyl groups, halogenated alkyl groups, aryl groups, aralkyl groups, and alkaryl groups on the organopolysiloxane backbone. In addition, an organohydrogenpolysiloxane containing at least two organohydrogensiloxane or hydrogensiloxane units per molecule, a platinum catalyst, an addition-reaction retarder and a photoinitiator are also disclosed. The alkenyl groups must be bonded directly to the silicone atom without an organo group therebetween. The Eckberg and Sasaki patents are also limited to very thin coatings.

Dual curing compositions employing UV- and moisture-cure mechanisms have a basic disadvantage in that once exposed to ambient moisture, they begin to cure. In many cases, this results in premature curing and shortened shelf life, as well as pot life. The advantage of the moisture cure mechanism is that it provides a means to cure shadow areas which are blocked from UV light. This is particularly important when high temperature curing is not an option due to the heat sensitivity of the substrate to which the reactive silicone is applied. For example, in conformal coatings where the substrate is an electronic circuit board, high temperature curing systems such as those which use peroxides, are not practical. Conventionally, moisture, UV, heat or combinations thereof curing mechanisms have been employed for such applications. More recently, as disclosed in the Sasaki and Eckberg patents above, heat and UV curing have been combined. While these patents disclose compositions which may be useful for heat sensitive substrates due to the combination of UV and low temperature heat cure, each requires a specific type of organopolysiloxane. In the case of the Eckberg patent, the organopolysiloxane backbone must contain both a hydrogen atom bonded to silicon as well as an olefinic group bonded to the silicon. In the Sasaki patent, the organopolysiloxane must contain an alkenyl group bonded directly to the silicone.

It would be desirable to overcome the disadvantages of dual curing compositions using moisture, as well as the limitations of using the specific polyorganosiloxanes of the Sasaki and Eckberg patents. However, while reactive organosiloxane compounds containing vinyl groups have been known to heat cure in the presence of a silicon hydride cross-linker and a hydrosilation catalyst, and UV curing mechanisms have been known to polymerize reactive organopolysiloxanes containing vinyl groups in the presence of compounds containing Si—SH groups, attempts to combine the use of hydrosilation/platinum mechanisms with photoinitiated mechanisms have not always been successful due to the interaction of the platinum catalyst with the mercapto groups or similar groups which are bonded to silicon. When heat is used to cure compositions which include the combination of silicon hydride/Pt and silicon-mercapto in the same composition, no substantial heat curing is observable. This is due to the attack of the mercapto group on the platinum. The same undesirable reaction occurs between Pt and —NH and —Sn groups. In this regard, such attempts have not produced successful dual curing compositions.

It would be desirable to provide the advantages of conventional moisture/UV dual curing systems without using the moisture curing mechanism, while avoiding potential interfering reactions of the heat curing hydrosilation catalysts with cross-linking compounds containing —SH,—NH and —Sn groups. Moreover, it would further be desirable to provide a reactive polyorganosiloxane which has the ability to cure through a variety of thicknesses and does not require direct silicon bonding of the reactive functional group.

### SUMMARY OF THE INVENTION

The present invention provides compositions which cure using actinic radiation such as UV radiation and/or either room temperature or low heat curing mechanisms by virtue of the presence of a platinum catalyst and a hydrogen siloxane compound. More specifically, the invention provides a dual curing silicone composition which includes a reactive polyorganosiloxane having olefinic unsaturation and being curable by actinic radiation and/or heat, said polyorganosiloxane containing at least one reactive functional group and desirably two groups selected from the group consisting of (meth)acrylate, carboxylate, maleate, cinnamate and combinations thereof and which is not attached directly to a silicon atom, i.e. an intervening chemical moiety separates the silicon atom from the reactive functional group. The composition further includes a silicon hydride crosslinker; an organo-metallic hydrosilation catalyst; and a photoinitiator. These compositions are specifically designed to be curable by both actinic radiation and/or heat. When thermal cure is desired, the temperatures required to obtain cure should be relatively low, such as at about room temperature. The dual curing silicone compositions can further include a hydrolyzable group on the polyorganosiloxane which permits the potential for further curing mechanism via moisture. When such hydrolyzable groups are present, the composition may optionally include a moisture curing catalyst.

For purposes of this invention the term “actinic radiation” is meant to include particle or wave electromagnetic radiation and photochemical radiation.

The present invention seeks to provide an improvement over reactive polyorganosiloxane polymers which depend on vinyl groups for cure. The present invention allows for enhanced UV cure capability and completeness of cure in a relatively short time frame without requiring secondary heat cure. The dual mechanisms provide equally useful independent methods of obtaining cure. The present invention does not suffer from the limitation of the thin coatings of the Eckberg and Sasaki patents and either cure mechanism can be used to cure a range of thicknesses, for example, up to 50 mm or more. The advantages of the present invention are believed to be attributed to the presence of the aforementioned reactive functional groups separated from the silicon atom by the intervening chemical moiety.

The polyorganosiloxane may contain methacryloxypropyl groups which participate in crosslinking via actinic radiation. Desirably, the actinic radiation used herein should be ultraviolet (UV) light, although other sources of electromagnetic or photochemical radiation are contemplated. The compositions of the present invention can be formulated into one or two part systems and are useful for a wide variety of applications. In particular, these dual curing, and optionally tri-curing systems, are suitable for conformal coatings and the like, to be used, for example, in electronic applications, such as circuit boards. Compositions of the present invention permit thicker films to be cured via actinic radiation due to the presence of the (meth)acrylate, carboxylate, maleate or cinnamate groups present on the polyorganosiloxane backbone.

### DETAILED DESCRIPTION OF THE INVENTION

The reactive polyorganosiloxanes having olefinic unsaturation should contain at least one reactive functional group, and desirably two reactive functional groups, selected from the group consisting of (meth)acrylate, carboxylate, maleate, cinnamate and combinations thereof and which are not directly bonded to a silicon atom, but rather to an intervening group or chemical moiety as further described herein. More than two reactive functional groups are also contemplated. The number and type of functional group or groups present can be varied according to the desired properties of the final silicone composition. Due to the presence of these functional groups, coatings prepared from these compositions can be cured via actinic radiation, desirably UV light, in thicknesses considerably greater than compositions known heretofore. The ability to cure via actinic radiation through a variety of thicknesses, for example, from about 0 mm up to about 50 mm, allows for a variety of coating and/or potting applications heretofore not permitted by other conformal coatings using UV curing mechanisms. For example, the Eckberg patent either does not cure or only partially cures at thicknesses of 8 mm. (See Table 1, Column 10). Moreover, the Sasaki patent uses one gram per square meter of his composition as a coating, presumably due to the inability to or difficulties in cure at greater thicknesses. Thus, the advantages obtained by the specific functional groups on the polyorganosiloxane backbone of the present invention are readily apparent.

The reactive polyorganosiloxanes of the present invention desirably should be in accordance with formula I below:

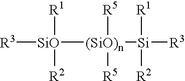

wherein R¹, R², R³ and R⁵ can be the same or different and are substituted or unsubstituted hydrocarbon or hydrocarbonoxy radicals from C₁₋₂₀, provided that at least one of these R groups, and desirably more than one, are selected from the reactive functional groups consisting of (meth)acrylate, carboxylate, maleate, cinnamate and combinations thereof, and provided that the reactive functional group is not directly bonded to a silicon atom, but separated from the silicon atom by an intervening chemical moiety, such as an atom or chemical group. For example, when one or more of the aforementioned R groups (R¹, R², R³ and R⁵) is not one of the required reactive functional groups, they can be chosen from alkyl radicals such as methyl, propyl, butyl and pentyl; alkenyl radicals such as vinyl and allyl; cycloalkyl radicals such as cyclohexyl and cycloheptyl; aryl radicals such as phenyl; arylalkyl radicals such as beta-phenylethyl; alkylaryl radicals; and hydrocarbonoxy radicals such as alkoxy, aryloxy, alkaryloxy, aryalkoxy, and desirable methoxy, ethoxy or hydroxy, and the like. Any of the foregoing radicals having some or all of the hydrogen atoms replaced, for example, by a halogen such as flourine or chlorine. One or more of the aforementioned R groups can also be hydrogen, provided the required reactive functional group is present as indicated and the presence of the hydrogen does not deleteriously interfere with the ability of the polyorganosiloxane to perform in the present invention. R³ in the above formula desirably is:

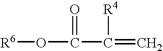

wherein R⁶ is a substituted or unsubstituted hydrocarbon radical C₁₋₂₀ and desirably is an alkyl group such as propyl; and R⁴ is H or CH₃.

The number of repeating units in the reactive polyorganosiloxanes can be varied to achieve specific molecular weights, viscosities and other chemical or physical properties. Generally n is an integer such that the viscosity is from about 25 cps to about 2,500,000 cps at 25° C., such as when n is from 1 to 1,200 and desirably from 10 to 1,000.

Desirably the reactive polyorganosiloxane has formula II below:

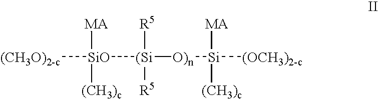

wherein MA is a methacryloxypropyl group, n is from 1 to 1,200 and c is 0 or 1; and R⁵ is a substituted or unsubstituted hydrocarbon or hydrocarbonoxy radical from C₁₋₂₀ as further defined herein.

The reactive polyorganosiloxanes should be present in amounts of about 50 to about 95%, and desirably in amounts of about 60 to about 80% by weight.

The silicon hydride crosslinker may be selected from a wide variety of compounds, although the crosslinker desirably conforms to formula III below:

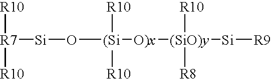

wherein at least two of R⁷, R⁸ and R⁹ are H; otherwise R⁷, R⁸ and R⁹ can be the same or different and can be a substituted or unsubstituted hydrocarbon radical from C₁₋₂₀ such hydrocarbon radicals including those as previously defined for formula I above; thus the SiH group may be terminal, pendent or both; R¹⁰ can also be a substituted or unsubstituted hydrocarbon radical from C₁₋₂₀ such hydrocarbon radicals including those as previously defined for formula I above, and desirably is an alkyl group such as methyl; x is an integer from 10 to 1,000; and y is an integer from 1 to 20. Desirably R groups which are not H are methyl. The silicon hydride crosslinker should be present in amounts sufficient to achieve the desired amount of crosslinking and desirably in amounts of about 1 to about 10% by weight of the composition.

The organo-metallic hydrosilation catalyst may be selected from any precious metal or precious metal-containing catalyst effective for initiating a thermal hydrosilation cure reaction. Especially included are all of the well known platinum and rhodium catalysts which are effective for catalyzing the addition reaction between silicone-bonded hydrogen atoms and silicone-bonded olefinic groups. Examples of platinum or platinum-containing complexes include platinum metal on charcoal, the platinum hydrocarbon complexes described in U.S. Pat. Nos. 3,159,601 and 3,159,662, the platinum alcoholate catalysts described in U.S. Pat. No. 3,220,970, the platinum complexes described in U.S. Pat. No. 3,814,730 and the platinum chloride-olefin complexes described in U.S. Pat. No. 3,516,946. Each of these patents relating to platinum or platinum-containing catalysts are hereby expressly incorporated herein by reference.

The classes of catalysts include, in addition to organoplatinum and organoplatinum complexes, organorhodium and platinum alcoholates. Complexes of ruthenium paladium, oznium and arridium are also contemplated. Organoplatinum catalysts are particularly useful herein. Of the non-platinum based catalysts useful, those based on rhodium are most preferred. The organometallic hydrosilation catalysts may be used in any effective amount to effectuate thermal curing. Preferably the catalyst is present in amounts of about 0.025% to about 1.0% by weight. Combinations of various precious metal or precious metal-containing catalysts are contemplated. The amount of this catalyst is not critical so long as proper crosslinking is achieved.

The photoinitiators useful in the present invention may be selected from any known free radical type photoinitiator effective for promoting crosslinking. For example, suitable photoinitiators include UV initiators such as benzophenone and substituted benzophenones, acetophenone and substituted acetophenones, benzoin and its alkylesters, xanthone and substituted xanthones. Desirable photoinitiators include diethoxyacetophenone, benzoin methyl ether, benzoin ethyl ether, benzoin isopropyl ether, diethoxyxanthone, chloro-thio-xanthone, azo-bisisobutyronitrile, N-methyl diethanolaminebenzphenone, and combinations thereof.

Visible light initiators include camphoroquinone peroxyester initiators and non-fluorene-carboxylic acid peroxyesters.

Particularly desirable photoinitiators include diethoxyacetophenone (DEAP). While the photoinitiator may be present in any effective amount, desirable ranges include about 1 to about 10% by weight, and about 2 to about 6% by weight.

The reactive organopolysiloxanes of the present invention can optionally contain one or more hydrolyzable groups in addition to the olefinic unsaturated group. In such cases, the composition is then capable of moisture curing. Such moisture curing compositions further include a moisture curing catalyst. Non-limiting examples of hydrolyzable groups useful in the present invention include amino, oxime, hydroxyl, alkoxy, aryloxy, alkaryloxy, aryalkoxy and the like.

Ultraviolet radiation useful sources include conventional mercury-vapor lamps designed to emit ultraviolet energy in various ultraviolet wavelength bands. For example, useful radiation wavelength ranges include 220 to 400 nms.

It should be understood that while the photoinitiator is generally used as a separate component, the formulations used in the inventive composition are intended to include those in which photoinitiating groups are included in the backbone of the same organopolysiloxane polymer which includes the photocuring groups.

The inventive compositions may also contain other additives so long as they do not interfere with the curing mechanisms. For example, conventional additives such as fillers, promoters, pigments, moisture scavengers, inhibitors and the like may be included. Fillers such as fumed silica or quartz are contemplated, as are moisture scavengers such as methyltrimethoxysilane and vinyl trimethoxysilane. Fillers may be present in amounts up to about 30% and preferably in amounts of about 5 to about 20%. Inhibitors may be present in amounts of about 10%, and preferably about 0.5 to about 1% by weight. The particular amount of inhibitor may be required to be carefully balanced in a given composition to produce or improve stability of the composition. Adhesion promoters may be present in amounts of up to about 5%, and preferably up to about 2% by weight.

UV cure is generally effectuated in the range of 40 milliwatts to about 150 milliwatts/cm², such as in the range of about 70 to about 100 milliwatts/cm². Heat curing may vary depending on the formulation, specific application and desired properties. For example, room temperature cure is contemplated, as well as temperatures in the range up to about 150° C., such as from about 65 to about 125° C. and desirably in the range of 85° C. to about 100° C. Although heat curing can be effectuated at higher temperatures than these given, the preferred lower temperatures allow for use of the compositions in applications, such as conformal coatings for electronic circuit boards, which are temperature sensitive.

The invention may be further understood with reference to the following non-limiting examples. Percent weights are per the total composition unless otherwise specified.

### EXAMPLE 1

This example demonstrates that a reactive organopolysiloxane of the present invention does not heat cure absent a hydrosilization catalyst and silicon hydride compound. An alpha, omega acrylate terminated polydimethylsiloxane having a molecular weight of about 2,000 was mixed with the photoinitiator diethoxyacetophenone (DEAP). This mixture was 97% reactive polyorganosiloxane and about 3% photoinitiator. When exposed to UV light for 18 seconds at an intensity of approximately 70 milliwatts per cm², a rubbery solid was formed. This indicates excellent UV cure. However, the liquid mixture remained liquid even after the 5 hours in an oven at 150° C., indicating no heat cure took place.

### EXAMPLE 2

To the composition of Example 1 was added a platinum inhibitor, namely dimethyl hexyne-ol and a platinum hydrosilation catalyst. No silicon hydride component was added. The liquid mixture again became a rubbery solid when exposed to UV light for 18 seconds, in accordance with Example 1, and again remained liquid even after 1 hour in an oven at temperatures of about 150° C. Again, no heat cure occurred.

### EXAMPLE 3

This example shows that when each of the components of the present invention are present, both UV and heat cure occur. To the composition of Example 2 was added a silicon hydride functional crosslinker. The mixture was then subjected to the same exposure of UV light and became a rubbery solid within 18 seconds. Additionally, when a separate sample of this composition was placed in an oven at 150° C., a rubbery solid occurred in 15 minutes, indicating heat cure has taken place.

### EXAMPLE 4

This example demonstrates that the presence of a thiol or mercapto group in compositions of the present invention results in a composition which is not heat curable and only partially UV responsive. This is due to the reaction between the thiol group and the platinum catalyst. 50 grams of a platinum-curable formulation containing vinyl siloxane, silicon hydride platinum catalyst and platinum inhibitor were added to a UV curable formulation. The UV curable formulation contained 43.5 grams of vinyl-terminated polydimethylsiloxane (200 centistokes viscosity), 5 grams of polydimethylsiloxane having about 5 mercaptopropyl pendant groups per polymer chain with an approximate molecular weight of about 3,000 and 1.5 grams of diethoxyacetophenone. These components were mixed in a plastic bottle. 2 grams of the final mixture were placed in an aluminum dish and exposed to UV light, at 70 milliwatts/cm² at 365 nanometers for 60 seconds. Subsequent to UV exposure, the material had increased in viscosity, but was still wet. Stirring appears to separate or collect the gelled material.

Two grams of another sample of the above prepared composition was weighed out and placed in an oven at 150° C. for about 10 minutes. No curing was observed. Mixing of the platinum heat-curable silicone formulation with a thiol-ene UV curable silicone formulation results in a material which is not heat curable and only partially UV responsive. This is due to the fact that the mercapto group and platinum are reacting, thereby preventing the availability of the platinum to crosslink the SiH group.

The invention being thus described, it will be obvious that the same may be varied in many ways. Such variations are not to be regarded as a departure from the spirit and scope of the invention and all such modifications are intended to be included within the scope of the following claims.

What is claimed is:

1. A dual curing silicone composition comprising:
a) a reactive polyorganosiloxane having the formula: 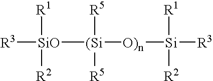
wherein R¹, R², R³ and R⁵ can be the same or different and are substituted or unsubstituted hydrocarbon or hydrocarbonoxy radicals from C₁₋₂₀, provided that at least one of these R groups is an ethylenically unsaturated carboxylate, and provided that the reactive functional group is not directly bonded to a silicon atom, wherein n is from 1 to 1,200;
b) a silicon hydride crosslinker;
c) an organo-metallic hydrosilation catalyst; and
d) a photoinitiator; and

2. The composition of claim 1, wherein said reactive polyorganosiloxane has the formula:
wherein R¹, R², R³ and R⁵ can be the same or different and are substituted or unsubstituted hydrocarbon or hydrocarbonoxy radicals from C₁₋₂₀, provided that at least one of these R groups are selected from the reactive functional groups consisting of (meth)acrylate, carboxylate, maleate, cinnamate and combinations thereof, and provided that the reactive functional group is not directly bonded to a silicon atom.

3. The composition of claim 1 wherein said polyorganosiloxane has the formula: 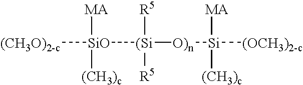
wherein MA is a methacryloxypropyl group, R⁵ is a substituted or unsubstituted hydrocarbon or hydrocarbonoxy radical from C₁₋₂₀, n is from 1 to 1,200 and c is 0 or 1.

4. The composition of claim 3, wherein the composition further includes a moisture curing catalyst.

5. The composition of claim 1, wherein the reactive polyorganosiloxane is present in the range of about 50% to about 95% by weight of said composition.

6. The composition of claim 1, wherein the silicon hydride crosslinker has the formula: 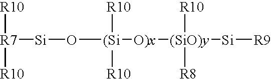
wherein at least two of R⁷, R⁸ and R⁹ are H; otherwise R⁷, R⁸ and R⁹ can be the same or different and can be a substituted or unsubstituted hydrocarbon radical from C₁₋₂₀; R¹⁰ can also be a substituted or unsubstituted hydrocarbon radical from C₁₋₂₀; x is an integer from 10 to 1,000; and y is an integer from 1 to 20.

7. The composition of claim 1, wherein the silicon hydride crosslinker is present in amounts of about 1% to about 10% by weight of said composition.

8. The composition of claim 1, wherein the organo-metallic hydrosilation catalyst is selected from the group consisting of organoplatinum, organorhodium, organoplatinum complexes, organorhodium complexes, platinum alcoholates and combinations thereof.

9. The composition of claim 1, wherein the organo-metallic hydrosilation catalyst is present in amounts of about 0.025% to about 1.0% by weight of said composition.

10. The composition of claim 1, wherein the photoinitiator is selected from a group consisting of benzophenones, acetophenones, xanthones, benoin, alkylesters of benzoin and mixtures thereof.

11. The composition of claim 1, wherein the photoinitiator is present in amounts of about 1% to about 10% by weight of said composition.

12. The composition of claim 1, further including at least one hydrolyzable group.

13. The composition of claim 12, wherein the hydrolyzable group is selected from the group consisting of alkoxy, aryloxy alkaryloxy, aryalkoxy, amino, hydroxyl and combinations thereof.

14. The composition of claim 12, which further includes a moisture curing catalyst.

15. A conformal coating composition formed by the reaction product of:
a) a reactive polyorganosiloxane having the formula: 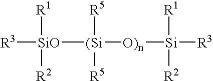
wherein R¹, R², R³ and R⁵ can be the same or different and are substituted or unsubstituted hydrocarbon or hydrocarbonoxy radicals from C₁₋₂₀, provided that at least one of these R groups is a carboxylate, and provided that the reactive functional group is not directly bonded to a silicon atom;
b) a silicon hydride crosslinker;
c) an organo-metallic hydrosilation catalyst; and
d) a photoinitiator.

16. A method of forming a conformal coating comprising the steps of:
1) applying a dual curing silicone composition to a substrate comprising:
a) a reactive polyorganosiloxane having the formula: 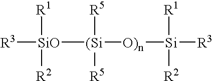
wherein R¹, R², R³ and R⁵ can be the same or different and are substituted or unsubstituted hydrocarbon or hydrocarbonoxy radicals from C₁₋₂₀, provided that at least one of these R groups is an ethylenically unsaturated carboxylate, and provided that the reactive functional group is not directly bonded to a silicon atom;
b) a silicon hydride crosslinker;
c) an organo-metallic hydrosilation catalyst; and
d) a photoinitiator; and
2) exposing said composition to a curingly effective amount of actinic radiation and/or heat to effectuate a cured conformal coating.

17. A method of making a dual curing silicone composition comprising the steps of:
combining in admixture; 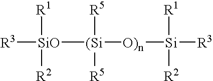
a) a reactive polyorganosiloxane having the formula:
wherein R¹, R², R³ and R⁵ can be the same or different and are substituted or unsubstituted hydrocarbon or hydrocarbonoxy radicals from C₁₋₂₀, provided that at least one of these R groups is an ethylenically unsaturated carboxylate, and provided that the reactive functional group is not directly bonded to a silicon atom;
b) a silicon hydride crosslinker;
c) an organo-metallic hydrosilation catalyst; and
d) a photoinitiator.

18. The composition of claim 1 wherein said carboxylate is selected from the group consisting of (meth)acrylate, maleate, cinnamate and combinations thereof.

19. The conformal coating composition of claim 15 wherein said carboxylate is selected from the group consisting of (meth)acrylate, maleate, cinnamate and combinations thereof.

20. The method of claim 16 wherein said carboxylate is selected from the group consisting of (meth)acrylate, maleate, cinnamate and combinations thereof.

21. The method according to claim 17 wherein said carboxylate is selected from the group consisting of (meth)acrylate, maleate, cinnamate and combinations thereof.
